(19) United States
(12) Patent Application Publication
(10) Pub. No.: US 2014/0379403 A1
(43) Pub. Date: Dec. 25, 2014

(54) MODIFYING SERVICE LEVELS IN ONLINE MEETING SYSTEM

(71) Applicant: INTERNATIONAL BUSINESS MACHINES CORPORATION, Armonk, NY (US)

(72) Inventors: Lorraine M. Herger, Port Chester, NY (US); Neal M. Keller, Pleasantville, NY (US); Matthew A. McCarthy, Holly Springs, NC (US); Clifford A. Pickover, Yorktown Heights, NY (US)

(21) Appl. No.: 13/924,484

(22) Filed: Jun. 21, 2013

(51) Int. Cl. G06Q 10/10

(52) U.S. Cl. CPC G06Q 10/1095
USPC 705/7.19

(57) ABSTRACT

Systems, methods and computer program products for modifying of service levels based on contextual data of meeting entries in electronic calendars. An example system includes an electronic calendar module executed by a central processing unit. The electronic calendar module is configured to store a meeting entry for a scheduled meeting. The meeting entry includes contextual data for the scheduled meeting. A context-determining module is configured to determine a context for the scheduled meeting based on the contextual data. A service-modifying module is configured to automatically modify a service level of the scheduled meeting based on the context of the scheduled meeting.

### BACKGROUND

The present invention relates to modification of communication service levels. More particularly, the present invention relates to modification of communication service levels based on contextual data of meeting entries in electronic calendars.

A service level agreement (SLA) is a negotiated contract between a service provider and one or more service consumers. Modern communication services are often delivered according to SLAs. The SLA typically specifies the services provided and the service's performance guarantees, also known as quality of service (QoS). Generally, the service's cost to the service consumer is proportional to the service level delivered by a service provider.

There has been a trend to shift organizational communication infrastructure from on-site to cloud-based services. This shift has placed greater emphasis on procuring a service level that corresponds to an organization's actual needs. Underestimating an organization's service level needs may cause communication outages or unacceptable communication quality. On the other hand, overestimating the organization's service level needs may result in wasted resources.

### BRIEF SUMMARY

Accordingly, one example aspect of the present invention is a system for conducting an online meeting. The system includes a central processing unit and an electronic calendar module executed by the central processing unit. The electronic calendar module is configured to store a meeting entry for a scheduled meeting. The meeting entry includes contextual data for the scheduled meeting. The system further includes a context-determining module configured to determine a context for the scheduled meeting based on the contextual data. A service-modifying module is configured to automatically modify a service level of the scheduled meeting for an attendee of the scheduled meeting based on the context of the scheduled meeting.

Another example aspect of the present invention is a method for operating an online meeting system. The method includes determining, by a central processing unit, a context for a scheduled meeting based on contextual data in a meeting entry for the scheduled meeting. A modifying step automatically modifies a service level of the scheduled meeting for an attendee of the scheduled meeting based on the context of the scheduled meeting.

Yet another example aspect of the present invention is a computer program product for modifying service levels for meetings. The computer program product includes computer readable program code configured to determine, by a central processing unit, a context for a scheduled meeting based on contextual data in a meeting entry for the scheduled meeting, and automatically modify a service level of the scheduled meeting for an attendee of the scheduled meeting based on the context of the scheduled meeting.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows an example system for conducting an online meeting contemplated by the present invention.

FIG. 2 shows an example method for operating an online meeting system in accordance with another embodiment of the invention.

FIG. 3 shows an exemplary system for implementing the present invention.

### DETAILED DESCRIPTION

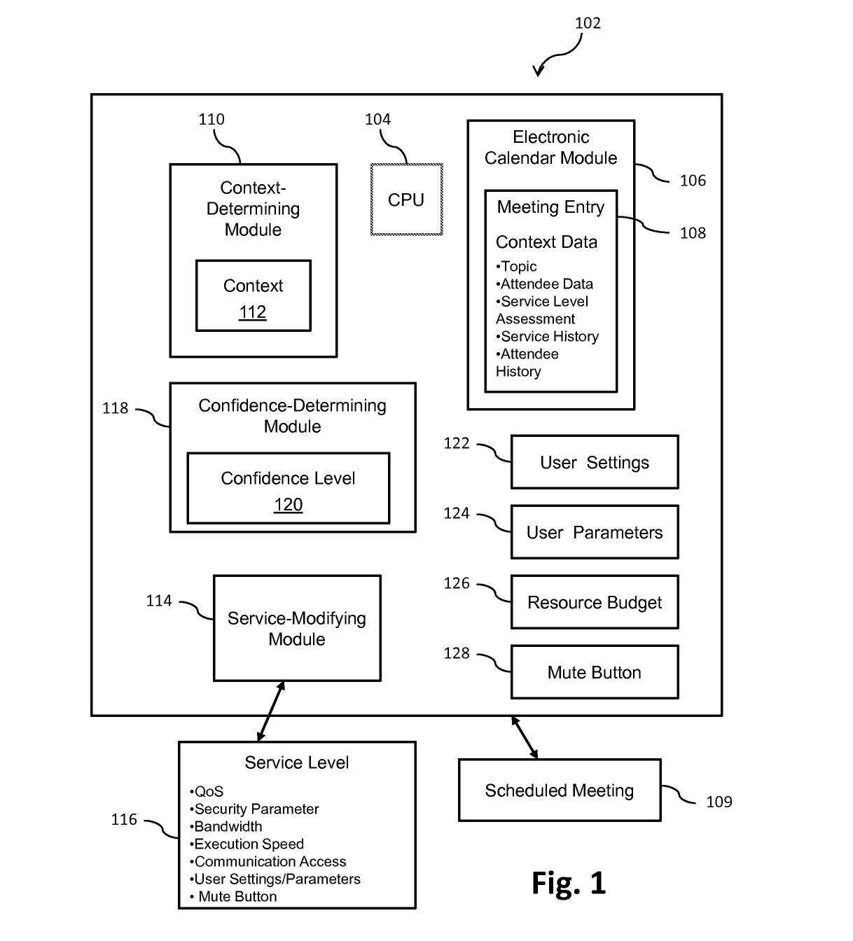

The present invention is described with reference to embodiments of the invention. Throughout the description of the invention reference is made to FIGS. 1-3. When referring to the figures, like structures and elements shown throughout are indicated with like reference numerals.

Embodiments of the present invention include a system and method comprising 1) a context-determining component and 2) a confidence-assessment component for a user of a computing device, followed by 3) dynamic modification of a service level from a service-level agreement based on information provided by the components. For example, context may be based on information in an electronic calendar (e.g., meeting information), and confidence may be based on an assessment of the service levels of other participants in a meeting.

In addition to information in an electronic calendar, context may also be based on any of the following: an assessment of who a person is talking to on the phone or interacting with using email (or instant messages), an assessment of an application being used (e.g., service level changes if using a home email system verses a business email system), real-time location of user (e.g., based on GPS), or the number of people and the nature of people at a meeting. In a virtual world scenario, context may also be determined based on a blending of the user's virtual location and real-world location, with an optional weighting factor used to weight the relative importance of virtual and real-world locations in determining context.

The service level may control any of: quality of service, bandwidth, security, priority; speed of application running on a cloud; access to particular servers on a cloud; or the amount of information downloaded (e.g., a low-resolution image verses a high-resolution image). The value of the confidence level may be based on any of: service levels of participants in a meeting or a history of service levels of the user and/or his social network.

FIG. 1 shows an example system 102 for conducting an online meeting contemplated by the present invention. The system includes an electronic calendar module 106 executed by a central processing unit 104. The electronic calendar module 106 is configured to store a meeting entry 108 for a scheduled meeting 109. As mentioned above, the meeting entry 108 includes contextual data for the scheduled meeting 109.

A context-determining module 110 is configured to determine a context 112 for the scheduled meeting 109 based on the contextual data. Contextual data may include, for example, a topic of the scheduled meeting and/or attendee data associated with the scheduled meeting. The attendee data may include an attendee's name, job title, and biographical data from a software program. For example, the context-determining module 110 may communicate with a third-party social media software program and retrieve an attendee's biographical data. The contextual data may include an assessment of the service levels from attendees of the scheduled meeting, a service usage and service level modification history of the attendees of the scheduled meeting, a location in a virtual world, and/or a history of participation of the attendees of the scheduled meeting in prior meetings.

The system 102 can include a service-modifying module 114 configured to automatically modify a service level 116 of the scheduled meeting 109 for an attendee of the scheduled meeting based on the context 112 of the scheduled meeting 109. In particular embodiments, the service level 116 can control a quality of service for a network application resource, a security parameter for the network application resource, a communication bandwidth for the network application resource, an execution speed of the network application resource, and/or communication access to a network server.

In one embodiment, the service-modifying module 114 is configured to modify the service level 116 based on user settings 122 and user parameters 124. The service-modifying module 114 can be configured to modify the service level 116 based on a resource budget 126 for the scheduled meeting such that individual attendees of the scheduled meeting can trade service level allocations from the resource budget. The service-modifying module 114 can also be configured to modify the service level 116 based on activation of a mute button 128 during the scheduled meeting 109.

The system may include a confidence-determining module 118 configured to determine a confidence level 120 of the determined context. In this embodiment, the service-modifying module 114 is configured to modify the service level 116 based on whether the confidence level 120 is greater than a confidence threshold.

Consider an example in which an individual tends to make use of various services, applications, and networks. The user may also have a complex electronic calendar that specifies the topic of meetings, the attendees of meetings, etc. Depending on the context the user finds herself in, the service level may change. For instance, the following sequence of steps emphasizes the automated scanning of a user's electronic calendar.

1. AC1 (analysis component 1) analyzes a user's electronic calendar (e.g. meeting topic, attendee names, etc.).

2. AC2 (analysis component 2) analyzes a plurality of possible service levels or service-level agreements associated with the calendar entry (e.g., quality of service, bandwidth, security, priority, speed of application running on a cloud, access to particular servers on a cloud, the amount of information downloaded (e.g., a low-resolution image verses a high-resolution image).

3. System computes action variable A=f(AC1 results, AC2 results).

4. System computes a confidence level C associated with A.

5. Based on A and C, system dynamically modifies service level of the service-level agreement.

For example, a user may have a certain activity scheduled on a calendar, such as an important meeting on the topic of salary plans. Topics of calendar entries may be determined by many means including text analysis, analysis of keywords, latent semantic indexing, etc. Based on the above sequence of steps (1-5), a service level may automatically change, for example, by the inventive system automatically sending a signal to a service provider to trigger such a change. For instance, the change may concern quality of service, bandwidth, and changes in cloud computing characteristics.

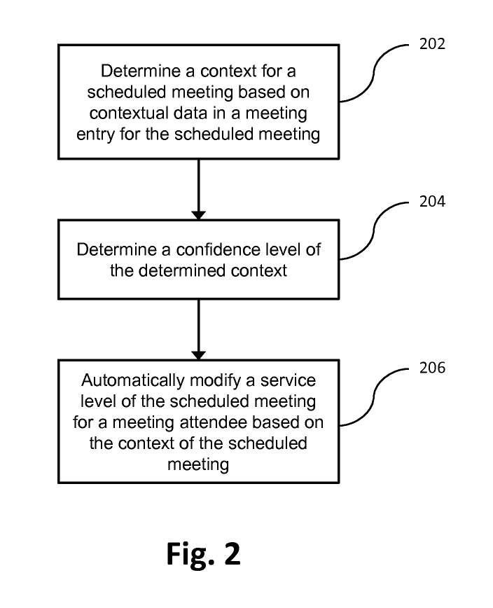

FIG. 2 shows an example method for operating an online meeting system contemplated by the present invention. The method includes determining step 202 for determining a context for a scheduled meeting based on contextual data in a meeting entry for the scheduled meeting.

As discussed above, the contextual data may include, for example, a topic of the scheduled meeting, attendee data associated with the scheduled meeting, an assessment of the service levels from attendees of the scheduled meeting, a service usage and service level modification history of the attendees of the scheduled meeting, or a history of participation of the attendees of the scheduled meeting in prior meetings. After determining step 202 is completed, process flow continues to determining step 204.

At determining step 204, a confidence level of the context is determined. The determined confidence level is discussed in greater detail below. After determining step 204 is completed, process flow continues to modifying step 206.

At modifying step 206, a service level of the scheduled meeting is automatically modified for an attendee of the scheduled meeting based on the context of the scheduled meeting. In one embodiment of the invention, the service level modification is additionally based on whether the determined confidence level is greater than a confidence threshold. As discussed above, automatically modifying the service level may be additionally based on user settings and user parameters, a resource budget for the scheduled meeting, and/or use of a mute button during the scheduled meeting. After modifying step 206 is completed, the process flow is completed.

As discussed above, a confidence level may be computed at determining step 204. If the confidence level C is low (e.g., because the automated analyses do not sufficiently specify the context or range of possible service levels), various confidence-increasing actions may be taken. Once C is above a threshold, then a service level can be modified. For example, if the confidence level is low because a user may have two meetings scheduled at the same time in an electronic calendar, the system may endeavor to determine which meeting the user is actually attending based on a history of a user's attending meetings, an estimate of a user's real-time location (e.g., as determined by IP address, GPS, etc.), and so forth. A range of possible service level options may be stored in a database.

Confidence can also be automatically boosted through other means. For example, the system can examine the service levels of other participants in a meeting held via a video-conference. Based on the values of their service levels, the user's service level may be changed. In addition, a history of a user's service level may be used to increase C. For example, if the user has in the past increased the service level in certain circumstances, the system may increase the confidence level associated with a particular potential current change in service level.

Note also that crowd-sourcing may be used to affect changes in service level. For example, if five people on a phone call suggest that a person's audio is degrading, a service level change may be suggested (and acted upon). If the service level is then increased and no improvement in quality results, the service level can be automatically reduced (e.g., returned to the previous settings). The results of such automated experiments may be stored and/or embodied as rules for future use.

In some situations, a technology-analysis module may attempt to analyze a user's settings and situation and determine what action is likely to boost quality (e.g., increase network bandwidth versus increase I/O capability in a cloud computing system). In a related scenario, the context can also be used to trigger an “application killer” which may sometimes be useful to boost a quality level, for example, when too many unneeded tasks are running on the user's local device. By suspending or changing the priority of such applications, performance may be improved.

If the user is in a virtual world, context may be estimated by the user's current location. For example, the user may be in a virtual company building, home, bank, store, park, etc. Based on context, a service level may change. For example, an increase in network bandwidth or quality of service may be triggered when an avatar is in a virtual office building relative to a park. An increase in network bandwidth or quality of service may be triggered when the system automatically determines that the user is currently involved in a financial transaction on a particular virtual island with other avatars within a threshold radius.

In the virtual world scenario, context may also be determined based on a blending of the user's virtual location and real-world location, with an optional weighting factor used to weight the relative importance of virtual and real-world locations in determining contexts. Other parameters that may affect context of users of virtual worlds include: avatars within a threshold radius of the user and real people within a threshold radius of the user.

Based on information from the context-determining component and confidence-assessing component, an aggregate QoS “need” (or service-level need) may be automatically determined and applied, where possible, to all participants (e.g., all participants in a meeting). Maximum and minimum allowed QoS or service levels may be set as needed. These maxima and minima may be specified during selection of possible services from a service catalog. The values of these parameters may be changed later, if needed.

Some attendees of a meeting may have no plans to contribute and thus may offer QoS points to those who may be contributors. This offering may be performed under user control (e.g., a meeting attendee selects a GUI button and offers the Qos points), or it may be performed automatically. In this manner, modifying the service level can be additionally based on a resource budget for the scheduled meeting such that individual attendees of the scheduled meeting can trade service level allocations from the resource budget.

For example, based on an analysis of a user's contribution in past meetings, QoS may be lowered or raised. A budget-determining component may be used to prevent users or groups from exceeding a financial budget. For example, if a departmental budget is $20,000 for QoS-related factors, and if the budget-determining component automatically determines that this threshold is likely to be reached within ten days, then QoS points and/or other service-level expenses may automatically be constrained.

Note that an on-the-fly assessment of points and/or QoS may be determined based on such parameters as the use of mute buttons, lists of speakers during a meeting, etc. For example, if an attendee is on mute in a teleconference, his QoS points may flow to an attendee who is frequently speaking. In a video context, these QoS points may control video resolution and frame update rates.

“Heat maps” of service level changes may be provided to users or policy makers. For example, these maps may indicate service levels, QoS trading, QoS aggregation changes, and so forth as colors on a map of a state, country, building, diagram of an organization, IP network, social network, etc. A history of such use, or an aggregate representation of such use, may be represented in a service catalog, to aid users in understanding usage patterns of various potential services.

Applications to gaming are envisioned since differential QoS may be of interest to gamers. Examination of service levels of other participants in a game may automatically change the service level of individual participants.

Applications to security are envisioned since differential security may be of interest to meeting participants. Examination of service levels of other participants(in terms of security) may automatically change the service level of individual participants.

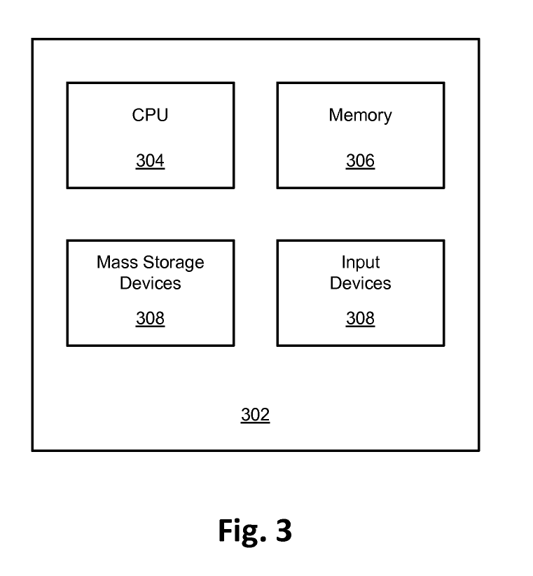

With reference to FIG. 3, an exemplary system for implementing the invention includes a computing device, such as device 302. In its most basic configuration, device 302 typically includes a processing unit 304 and memory 306. Depending on the exact configuration and type of computing device, memory 306 may be volatile (such as RAM, non-volatile (such as ROM, flash memory, etc.) or some combination of the two. Additionally, device 302 may also have mass storage 308 (removable and/or non-removable) such as a magnetic or optical disks or tape. Similarly, device 302 may also have input devices 310 such as a keyboard and mouse. Other aspects of device 302 may include network connections to other devices, computers, networks, servers, etc. using either wired or wireless media. All these devices are well known in the art and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A system for conducting an online meeting, the system comprising:
a central processing unit;
an electronic calendar module executed by the central processing unit, the electronic calendar module configured to store a meeting entry for a scheduled meeting, the meeting entry including contextual data for the scheduled meeting;
a context-determining module configured to determine a context for the scheduled meeting based on the contextual data; and
a service-modifying module configured to automatically modify a service level of the scheduled meeting for an attendee of the scheduled meeting based on the context of the scheduled meeting.

2. The system of claim 1, wherein the contextual data includes at least one of: a topic of the scheduled meeting; attendee data associated with the scheduled meeting, the attendee data including name, job title, and biographical data from a software program; an assessment of service levels from attendees of the scheduled meeting; a service usage and service level modification history of the attendees of the scheduled meeting; a history of participation of the attendees of the scheduled meeting in prior meetings; and a location in a virtual world.

3. The system of claim 1, wherein the service level controls at least one of a quality of service for a network application resource, a security parameter for the network application resource, a communication bandwidth for the network application resource, an execution speed of the network application resource, and communication access to a network server.

4. The system of claim 1, further comprising:
a confidence-determining module configured to determine a confidence level of the determined context; and
wherein the service-modifying module is configured to modify the service level based on whether the confidence level is greater than a confidence threshold.

5. The system of claim 1, wherein the service-modifying module is configured to modify the service level based on user settings and user parameters.

6. The system of claim 1, wherein the service-modifying module is further configured to modify the service level based on a resource budget for the scheduled meeting.

7. The system of claim 1, wherein the service-modifying module is further configured to modify the service level based on activation of a mute button during the scheduled meeting.

8-14. (canceled)

15. A computer program product for modifying service levels for meetings, the computer program product comprising:
a computer readable storage medium having computer readable program code embodied therewith, the computer readable program code configured to:
determine, by a central processing unit, a context for a scheduled meeting based on contextual data in a meeting entry for the scheduled meeting; and
automatically modify a service level of the scheduled meeting for an attendee of the scheduled meeting based on the context of the scheduled meeting.

16. The computer program product of claim 15, wherein the contextual data includes at least one of: a topic of the scheduled meeting; attendee data associated with the scheduled meeting, the attendee data including name, job title, and biographical data from a software program; an assessment of service levels from attendees of the scheduled meeting; a service usage and service level modification history of the attendees of the scheduled meeting; a history of participation of the attendees of the scheduled meeting in prior meetings; and a location in a virtual world.

17. The computer program product of claim 15, wherein the service level controls at least one of a quality of service for a network application resource, a security parameter for the network application resource, a communication bandwidth for the network application resource, an execution speed of the network application resource, and communication access to a network server.

18. The computer program product of claim 15, further comprising:
computer readable program code configured to determine a confidence level of the determined context; and
wherein automatically modifying the service level is additionally based on whether the confidence level is greater than a confidence threshold.

19. The computer program product of claim 15, wherein the computer readable program code configured to automatically modify the service level includes computer readable program code configured to automatically modify the service level based on user settings and user parameters.

20. The computer program product of claim 15, wherein the computer readable program code configured to automatically modify the service level includes computer readable program code configured to automatically modify the service level based on activation of a mute button during the scheduled meeting.
